(19) United States
(12) Patent Application Publication
(10) Pub. No.: US 2026/0296976 A1
(43) Pub. Date: Oct. 1, 2026

(54) COMPOSITION FOR ADJUSTING OF AIR PORES IN BUILDING PRODUCTS IN THE PRESENCE OF SULFATE-BASED SUPERPLASTICIZERS

(71) Applicant: BASF SE, Ludwigshafen am Rhein (DE)

(72) Inventors: Uwe GEHRIG, Trostberg (DE); Anja TRIEFLINGER, Trostberg (DE); Michael SCHINABECK, Trostberg (DE); Mirko MONTIGNY, Langenlonsheim (DE)

(21) Appl. No.: 19/475,836

(22) PCT Filed: Apr. 3, 2024
(86) PCT No.: PCT/EP2024/059007

§ 371 Date: Oct. 16, 2025

(30) Foreign Application Priority Data
Apr. 19, 2023 (EP) 23168653.6

(51) Int. Cl. C04B 28/14; C04B 11/26; C04B 24/22; C04B 40/00; C04B 103/30; C04B 103/40; C04B 103/50; C04B 111/40

(52) U.S. Cl. CPC C04B 28/14; C04B 11/264; C04B 24/226; C04B 40/0046; C04B 2103/304; C04B 2103/408; C04B 2103/50; C04B 2111/40

(57) ABSTRACT

Method for making light-weight gypsum board with enhanced compressive strength by addition of dispersants. Wallboards made by use of a gypsum-based composition comprising a ketone resin as dispersant and a foaming agent.

### TECHNICAL FIELD

The present invention relates to a binder composition for adjusting air pore sizes in building products in the presence of superplasticizers in the binder composition. In particular, the present invention relates to binder compositions comprising (a) an antifoaming agent; (b) an inorganic binder; (c) a foaming agent; and (d) a dispersant. The present invention further relates to a method for producing a hardened gypsum product having pores with a predetermined pore size, with said composition.

### BACKGROUND

Hardened gypsum products, such as gypsum building panels offer a high-performance product for a reasonable price for finishing of building spaces. Gypsum, also known as calcium sulfate dihydrate, is heated to drive off crystalline water to produce calcium sulfate anhydrite and/or calcium sulfate hemihydrate, also known as stucco, calcined gypsum or Plaster of Paris. The building panels are made by combining stucco with water. Calcined gypsum and water are combined, and an interlocking matrix of gypsum crystals is formed.

After the hydration of the calcined gypsum, excess water is driven off by heating. The resulting product is a relatively strong panel, having a good surface for receiving decorative finishes such as paint or wallpaper.

Although gypsum building panels are cost effective, they are relatively heavy. The panels must be moved in small batches due to the weight. Installers, who work with the panels, become fatigued from lifting the panels and holding them in place to be secured.

Additionally, heavy panels are costly to transport. One method of controlling the density of the product is by the addition of a soap-based foam to the liquid slurry. The stucco then sets around the foam bubbles, creating voids in the gypsum matrix. It is important to control the size of the bubbles to avoid undesirable properties in the panels. If the bubbles are too small, a large number of small bubbles are needed to effect the change in density. Where there are lots of bubbles in a confined space, the resulting gypsum matrix has a low compressive strength. Bubbles that are too large tend to blister and thus are not able to keep air in the product to reduce gypsum product density. Moreover, blisters lead to surface defects. Thus, it has been found that if the gypsum is formed having not too small and homogeneous void sizes, it is possible to produce a building panel that is both strong and free of surface defects (cf. U.S. Pat. Nos. 5,643,510 A, 5,085,929 A).

Various foaming agents produce bubbles having different properties. Some foaming agents form bubbles that are very strong and stable, with little tendency to break and coalesce. For the purposes of this discussion, a stable foaming agent is defined as one developed to maximize air entrainment and minimize usage of itself in binder slurries. Other foaming agents are less stable, forming foam, but becoming more unstable in the presence of a binder, in particular gypsum. A combination of foaming agents that form stable and unstable foams allows for control of the production of larger foam voids in the gypsum slurry. Thus, it is a general desire to control the average bubble size of the foam in a range avoiding blisters formation and achieving a desired compression strength of the gypsum matrix at lower densities of the gypsum slurry.

Further, various types of organic compounds are usually applied to advantageously alter certain properties of wet hydraulic binder compositions. One class of components, which can collectively be called “superplasticizers”, fluidify or plasticize wet binder compositions to obtain a more fluid mixture. A controlled fluidity is desired, such that the aggregate used in mortars and concretes does not segregate from the binder paste. Alternatively, superplasticizers may allow, i.e., cement compositions to be prepared using a lower water:binder ratio in order to obtain a composition having a desired consistency. Such lower water:binder ratios often lead to a hardened composition having a higher compressive strength development after setting.

A good superplasticizer should not only fluidify the wet hydraulic binder composition to which it is added, but also maintain the level of fluidity over a desired period. This time should be long enough to keep the wet composition fluid, e. g. in a ready-mix truck while it is on its way to a job site. Another important aspect relates to the period for discharging the truck at the job site and the period needed for the cement composition for being worked in the desired final form. On the other side, the hydraulic mixture cannot remain fluid for a too long time, that means the set must not greatly be retarded, because this will slow down the work on the job and show negative influences on the characteristics of the final hardened products. Usual superplasticizers include sulfonated naphthalene formaldehyde condensate, sulfonated melamine formaldehyde condensate, acetone formaldehyde condensate and polycarboxylate ethers.

For example, in US 2011/0213043 A1, a gypsum building panel comprising hydraulic material, foam, a defoamer and a polycarboxylate dispersant, is disclosed.

Hence, by addition of sulfate-based superplasticizers, such as beta-naphthalene sulfonates or lignosulfonates, the flow behavior of a binder mixture can be improved. In the presence of foaming agents, however, not only the flow rate but also the air void structure in the binder mixture is changed, depending on the amount of superplasticizer added.

For example, in US 2011/0213043 A1, a gypsum building panel comprising hydraulic material, foam, a defoamer and a polycarboxylate superplasticizer, is disclosed.

However, polycarboxylate superplasticizers unlike sulfonate-based superplasticizers have the disadvantage that they do not improve the early compressive strength of a respective binder composition (Wu et al., Materials, 14, p. 662, 2021).

Another negative aspect is foam formation during the preparation of the binder system when superplasticizers are present in the composition.

WO 2011/029711 A1 relates to a gypsum slurry containing a compound with dispersing properties, characterized in that the slurry contains as dispersant a polycondensation product containing (I) at least one structural unit with an aromatic or heteroaromatic sub-unit and a polyether side chain and (II) at least one phosphated structural unit with an aromatic or heteroaromatic sub-unit, and preferably additionally (III) at least one structural unit with an aromatic or heteroaromatic sub-unit.

WO 2012/049077 A1 discloses a formulation containing at least one component having dispersing properties and selected from the group consisting of a compound at least containing a branched comb polymer having polyether side chains, a naphthalene sulfonate-formaldehyde condensate (“NSF”) and a melamine sulfonate-formaldehyde condensate (“MSF”), and b) a polycondensation product containing (I) at least one structural unit with an aromatic or heteroaromatic sub-unit and at least one polyether side chain, and (II) at least one phosphatized structural unit with an aromatic or heteroaromatic sub-unit, and (III) at least one structural unit with an aromatic or heteroaromatic sub-unit, the formulation being suitable as admixture for a hydraulic binder and preferably a calcium sulfate binder system containing composition.

However, both of these solutions use dispersants having polyether side chains. These dispersants tend to form low pore sizes resulting in lower compressive strengths.

U.S. Pat. No. 8,344,084 B2 relates to a liquid admixture composition for a calcium sulfate binder system containing composition comprising an aqueous composition comprising a) a copolymeric dispersing component, b) an antifoaming agent component, c) a surfactant component, and d) water. However, U.S. Pat. No. 8,344,084 B2 is not related to foamed products at all.

### SUMMARY OF THE INVENTION

Therefore, it is one object of the present invention to provide a binder composition suitable for adjusting an optimum size of the air bubbles in a slurry of water and the binder composition and, hence, the pore sizes of the hardened binder composition, independently of the quantity of superplasticizer present in the composition, and having improved early compressive strength.

It has been surprisingly found that the above-mentioned object can be solved by a binder composition comprising:
(a) an antifoaming agent selected from the group consisting of a mineral oil, a vegetable oil, a silicon oil, a silicon containing emulsion, a fatty acid, a fatty acid ester, an organic modified polysiloxane, a borate ester, an alkoxylate, a polyoxialkylene copolymer, an ethylene oxide (EO)-propylene oxide (PO) block polymer, an acetylenic diol, and a phosphoric ester having the formula P(O)(O—R¹)₃₋ₓ(O—R²)ₓ wherein P represents phosphorus, O represents oxygen and R¹ and R² are independently a C₂-C₂₀ alkyl, preferably a C₂-C₈ alkyl, or an aryl group and x=0, 1, 2;
(b) an inorganic binder;
(c) a foaming agent; and
(d) a dispersant comprising at least 30 wt % of a sulfonate group containing dispersant with respect to the of the total weight of the dispersant (d).

It has been further surprisingly found that above-mentioned object can be achieved by a method for producing a hardened binder product having pores with a predetermined pore size, the method comprising the steps of
(I) mixing water, an inorganic binder, and a dispersant yielding a binder slurry;
(II) providing a foaming agent;
(III) adding an antifoaming agent to the binder slurry of step (1) and/or the foaming agent of step (II);
(IV) combining the binder slurry and the foaming agent yielding a foamed binder slurry;
(V) forming the foamed binder slurry into an article; and
(VI) allowing the article to set,
wherein the antifoaming agent is added in an amount to adjust the pore sizes of the pores in the foamed binder product to a predetermined size;
wherein the antifoaming agent is selected from the group consisting of a mineral oil, a vegetable oil, a silicon oil, a silicon containing emulsion, a fatty acid, a fatty acid ester, an organic modified polysiloxane, a borate ester, an alkoxylate, a polyoxialkylene copolymer, an ethylene oxide (EO)-propylene oxide (PO) block polymer, an acetylenic diol, and a phosphoric ester having the formula P(O)(O—R)₃(O—R²)ₓ wherein P represents phosphorus, O represents oxygen and R¹ and R² are independently a C₂-C₂₀ alkyl, preferably a C₂-C₈ alkyl, or an aryl group and x=0, 1, 2; and wherein the dispersant comprises at least 30 wt % of a sulfonate group containing dispersant with respect to the of the total weight of the dispersant.

The inventors surprisingly found that by using an antifoaming agent and a dispersant as defined above, a binder composition can be provided, wherein the air bubble size in a slurry of water and the binder composition can be adjusted independently of the amount of dispersing agent present in the binder composition. This is necessary, among other things, for good strength of the construction products obtained by a slurry of water and the binder composition. In addition, a suitable antifoaming agent emulsion makes it possible to adjust the raw material fluctuations, e.g., in the production process of a gypsum plasterboard plant, as required—compensation of pore size changes due to gypsum.

### BRIEF DESCRIPTION OF THE DRAWINGS

FIG. 1 shows a picture of the air pore structure of hardened gypsum mixture of Inventive Example 1.

FIG. 2 shows a picture of the air pore structure of hardened gypsum mixture of Comparative Example 1.

FIG. 3 shows a picture of the air pore structure of hardened gypsum mixture of Comparative Example 2.

FIG. 4 shows a picture of the air pore structure of hardened gypsum mixture of Inventive Example 2.

FIG. 5 shows a picture of the air pore structure of hardened gypsum mixture of Comparative Example 3.

FIG. 6 shows a picture of the air pore structure of hardened gypsum mixture of Comparative Example 4.

### DETAILED DESCRIPTION OF THE INVENTION

The binder composition of the invention comprises
(a) an antifoaming agent selected from the group consisting of a mineral oil, a vegetable oil, a silicon oil, a silicon containing emulsion, a fatty acid, a fatty acid ester, an organic modified polysiloxane, a borate ester, an alkoxylate, a polyoxialkylene copolymer, an ethylene oxide (EO)-propylene oxide (PO) block polymer, an acetylenic diol, and a phosphoric ester having the formula P(O)(O—R¹)₃₋ₓ(O—R²)ₓ wherein P represents phosphorus, O represents oxygen and R¹ and R² are independently a C₂-C₂₀ alkyl, preferably a C₂-C₈ alkyl, or an aryl group and x=0, 1, 2;
(b) an inorganic binder;
(c) a foaming agent; and
(d) a dispersant comprising at least 30 wt % of a sulfonate group containing dispersant with respect to the total weight of the dispersant (d).

In a preferred embodiment, the antifoaming agent (a) comprises at least one compound selected from the group consisting of a trialkyl phosphate, a polyoxypropylene copolymer, an alcohol acetate, an ethylene oxide (EO)-propylene oxide (PO) block polymer, or mixtures thereof. More preferably, the antifoaming agent (a) comprises a trialkyl phosphate.

Preferable trialkyl phosphates are triisobutyl phosphate, tri-n-butyl-phosphate, triphenyl phosphate, triethyl phosphate, and tripropyl phosphate. Most preferably, the antifoaming agent (a) comprises, preferably consists of, triisobutyl phosphate.

The antifoaming agent (a) present in the binder composition of the invention allows for larger air bubbles in the binder slurry at a low amount of dispersing agent (d). Furthermore, by addition of antifoaming agent (a) to the binder composition of the invention, the size of air bubbles in a slurry of water and the binder composition can be advantageously adjusted at a constant amount of foaming agent (c) and independently from the amount of dispersing agent (d).

In a preferred embodiment, the inorganic binder (b) is selected from the group consisting of cement, gypsum, and a mixture thereof.

The term “cement” as used herein denotes a cement in accordance with the CEM classification as set forth for example in DIN EN 197-1. A preferred cement is ordinary Portland cement (OPC) according to DIN EN 197-1, which may either contain calcium sulfate (<7 wt %) or is essentially free of calcium sulfate (<1 wt %). Another preferred cement is sulfoaluminate cement (calcium sulfoaluminate cement, CSA) or high alumina cement (HAC) according to DIN EN 14647 or a mixture of ordinary Portland cement and aluminate cement, in particular a mixture of ordinary Portland cement and high alumina cement or a mixture of ordinary Portland cement and sulfoaluminate cement or a mixture of ordinary Portland cement, high alumina cement, and sulfoaluminate cement.

In the context of the present invention, the term “gypsum” relates to the compound calcium sulfate in its anhydrous or hydrated form, for example gypsum rock, consisting of this compound in crystalline form, and the corresponding building material such as calcium sulfate hemihydrate, dihydrate, or anhydrite of the formula CaSO₄xH₂O where x is 0, ½ or 2, or mixtures of these.

In a preferred embodiment, the gypsum is selected from the group consisting of natural gypsum, calcium sulfate, calcined gypsum, calcium sulfate hemihydrate, calcium sulfate anhydrite, plaster of Paris, synthetic gypsum, preferably formed as a by-product of flue gas desulfurization, or recycled gypsum.

In the context of the present invention, the term “recycled gypsum” relates to gypsum that has already been used in the production of gypsum-containing articles and has been recovered from said articles.

In a preferred embodiment, the recycled gypsum is recycled from at least one compound selected from the group consisting of stucco gypsums, mortar gypsums, machine gypsum plasters, plastering gypsums, bonding gypsums, jointing gypsums, filling gypsums, insulating gypsums, flooring gypsums, ready-mixed plaster gypsums, imitation marbles and gypsum-containing ready-made structural components. Additionally, the recycled gypsum may comprise siloxanes, wax emulsions, or combinations thereof.

The recycled gypsum content of the gypsum used in accordance with the invention is at least 0.5% by weight, more preferably at least 2.0% by weight, especially preferably at least 5.0% by weight, based on the total gypsum content.

Recycled gypsum generally comprises the additives present in the gypsum-containing articles that are integrated into the production process. For example, hydrophobized gypsum plasterboard panels that are used for wetroom finishing include siloxanes or wax emulsions.

Hence, the recycled gypsum preferably comprises siloxanes. Siloxanes are linear or cyclic compounds according to formula (I).

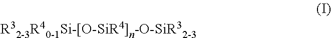

where R³ is hydrogen or an alkyl radical and R⁴, if present, is a —O— group that forms a ring closure between the terminal R³₂₋₃R⁴₀₋₁Si— and SiR³₂₋₃ groups and n can have values of 0 to 100. If R³ is an alkyl radical, it is preferably a linear or branched C₁-C₁₀-alkyl radical.

Preferably, R³ is methyl, ethyl, n-propyl, n-butyl, isobutyl or n-hexyl. More preferably, R³ is methyl.

In particular, the recycled gypsum contains at least 0.01 siloxanes, more preferably 0.02% to 5.0% by weight of siloxanes, and especially preferably 0.05% to 2.0% by weight, based on the total weight of the recycled gypsum.

The presence of siloxanes or other additives in the binder composition negatively influence the formed foam up to complete destruction of the foam. Hence, the present invention provides a binder composition and a method for foaming a hardened binder article therefrom, which can implement recycled gypsum or other inorganic binder comprising siloxanes or similar additives without an increase in foam quality (cf. WO 2019/081344 A2).

In a preferred embodiment, the foaming agent (c) comprises at least one compound selected from the group consisting of a nonionic surfactant, a bleach of desalts, a cationic surfactant, and a amphosurfactant. More preferably, the foaming agent (c) comprises at least one compound selected from the group consisting of an alkyl polyglycoside, a betaine, a glutamate, a sulfo ketone, an alkyl sulfate, an alkyl aryl, an alkyl ether, an alkyl aryl ether, an alkyl ether an isethionate, a N-acylamino acid compound, a sulfoacetate, a sulfonate, a sulfosuccinate, a taurate, an alkanolamide, an amine oxide, a carboxylate, a cationic polymer, a silicone, an alcohol, a protein derivative, and mixtures thereof.

Preferred alkyl polyglycosides are compounds according to formula (II).

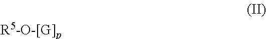

where R⁵ is a linear or branched alkyl and/or alkylene radical having 8 to 18 carbon atoms, G is a sugar residue having 5 or 6 carbon atoms, preferably G is glucose, and p is numbers from 1 to 10.

Preferred alkylamido betaines are compounds according to formula (III).

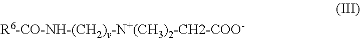

where R⁶ is a linear or branched alkyl or alkylene radical having 7 to 19 carbon atoms and y is an integer in the range of 2 to 4.

Preferable betaines are alkylamido betaines. Also preferably carboxylates are alkyl ethoxylates.

Preferably, the alkyl ether is selected from the group consisting of poly(ethyleneoxide) alkyl ether, poly(oxyethylene) alkyl ether, poly(oxypropylene) alkyl ether, (poly(ethylen-neoxide) alkyl ether, and poly(propyleneoxide) alkyl ether.

N-acylamino acid compounds are preferably N-acylglutamic acid compounds according to formula (IV).

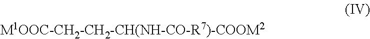

where R⁷ is a linear or branched alkyl or alkylene radical having 7 to 19 carbon atoms and the M¹ and M² radicals are independently selected from the group consisting of H, Li, Na, K, Ca/2, Mg/2, ammonium and alkanolamines.

Protein derivatives are preferably protein hydrolyzates.

Alkyl sulfates comprise linear or branched alkyl sulfates. Linear or branched alkyl sulfate are known in the art.

Exemplary embodiments of linear or branched alkyl sulfate are compounds of the formula (V):

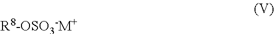

where R⁸ is a linear and/or branched hydrocarbon moiety having a maximum molecular weight of 253, preferably a linear or branched alkyl group containing 2 to 20 carbon atoms, more preferably 6 to 18 carbon atoms; and M is a monovalent cation including at least one selected from sodium, potassium, lithium, magnesium ammonium and mixture thereof.

Preferably, the alkyl sulfate is a alpha-sulfo fatty acid disalt. More preferably, the alpha-sulfo fatty acid disalt is a compound of the formula (VI)

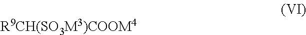

where R⁹ is a linear or branched alkyl or alkylene radical having 6 to 16 carbon atoms and M³ and M⁴ are independently H, Li, Na, K, Ca/2, Mg/2, ammonium or alkanolamine.

Particularly preferred alkanolamines here are monoethanolamine, diethanolamine, triethanolamine and monoisopropanolamine.

A further proviso applicable is that the alpha-sulfo fatty acid disalt comprises 3 wt % or less based on the total weight of the alpha-sulfo fatty acid salt of a compound according to formula (VI), in which the R⁹ radical is an alkylene radical.

Preferably, R⁹ is a saturated linear alkyl radical having 8 to 16 carbon atoms, more preferably 9 to 16 carbon atoms, especially preferably 10 to 12 carbon atoms.

More preferably, the proviso is applicable that the alpha-sulfo fatty acid disalt comprises 90% by weight or more, based on the total weight of the alpha-sulfo fatty acid salt of a compound according to formula (VI), in which the R⁹ radical is a decyl and/or dodecyl radical.

More preferably, M³ and M⁴ are Na.

Accordingly, the alpha-sulfo fatty acid disalt is especially preferably the disodium salt of 2-sulfododecanoic acid, the disodium salt of 2-sulfotetradecanoic acid, or a mixture thereof.

Most preferably, the alpha-sulfo fatty acid disalt is a mixture of the disodium salt of 2-sulfododecanoic acid and the disodium salt of 2-sulfotetradecanoic acid.

The compounds of the formula (VI) can be prepared by any relevant methods known to those skilled in the art. An especially preferred method of preparation is the sulfonation of the corresponding carboxylic acids. Such a preparation method involves reacting the corresponding carboxylic acid, especially the corresponding fatty acid, with gaseous sulfur trioxide, preferably in a molar ratio of SO₃ to fatty acid in the range of from 1.0:1 to 1.1:1.

The crude products thus obtained, which are acidic sulfonation products, are then partially or fully neutralized, preferably fully neutralized with aqueous NaOH.

In a preferred embodiment, the foaming agent (c) comprises at least 50 wt % with respect to the total weight of the foaming agent (c), preferably 60 wt %, and more preferably 70 wt %, of a compound selected from the group consisting of an alkyl sulfate, an alkyl polyglycoside, and a mixture thereof.

In a preferred embodiment, the antifoaming agent (a) and the foaming agent (c) are present in the composition in a ratio ((a):(c)) in the range of from 1:2000 to 1:1, preferably in a range of from 1:1800 to 1:5, more preferably in a range of from 1:1500 to 1:7, even more preferably in a range of from 1:1200 to 1:8, and particularly preferably in a range of from 1:1000 to 1:10.

The composition of the invention comprises a dispersant (d), wherein the amount of sulfonate group containing dispersant is at least 30% of the total weight of the dispersant.

Preferably, the dispersant (d) comprises at least 40 wt % of the sulfonate group containing dispersant with respect to the total weight of the dispersant (d), further preferably at least 60 wt %, more preferably at least 80 wt %, and even more preferably at least 90 wt %.

In an especially preferred embodiment, the dispersant (d) consists of the sulfonate group containing dispersant.

The presence of the dispersant (d) in the binder composition of the present invention has an impact on the size distribution of air bubbles in a slurry of water and the binder composition. A higher amount of the dispersant (d) leads to larger air bubbles in said slurry.

In the binder composition of the invention, a higher amount of the dispersant (d) enables further water reduction at the same flow.

In a preferred embodiment, the sulfonate group containing dispersant (d) is selected from the group consisting of a polynaphthalene sulfonate, a ketone resin, a melamine resin, a lignosulfonate, and mixtures thereof, preferably is naphthalene sulfonate-formaldehyde condensate. Preferably, polynaphthalene sulfonates are neutralized by calcium ions. An especially preferred polynaphthalene sulfonate is β-naphthalene sulfonate formaldehyde (BNS). A commercial available product is Flube CA 40 available by Bozetto (a calcium salt of polymer of naphthalenesulfonic acids condensed with formaldehyde).

Preferably, the ketone resin is synthetized from cyclohexanone or acetone and/or mixtures thereof, formaldehyde and sulfite, more preferably cyclohexanone, formaldehyde and sulfite (CFS) as the monomers. Preferably, the CFS-based ketone resin has a molecular weight between 10 000 and 40 000 g/mol, more specifically between 15 000 and 25 000 g/mol.

The lignosulfonate is preferably a water-soluble anionic polyelectrolyte polymer. Usually, lignosulfates are understood as byproducts from the production of wood pulp using sulfite pulping and are known to the person skilled in the art.

Polynapthalene sulfonates are derivatives of sulfonic acid which contain a naphthalene functional unit and are usually used as plasticizers for inorganic binders. They are produced on a large scale by condensation of naphthalenesulfonate or alkylnaphthalenesulfonates with formaldehyde.

Melamine resins are resins with melamine rings terminated with multiple hydroxyl groups derived from formaldehyde. Preferred melamine resins are melamine sulfonate/formaldehyde condensation products.

In a preferred embodiment, the composition further comprises a surfactant (e) selected from the group consisting of a styrene/maleic acid copolymer, an alcohol alkoxylate, an acetylenic diol, a monoalkylpolyalkylene, an alkylethersulfonate, and an alkyl ether carboxylate.

Preferably, the alcohol alkoxylate is an alcohol ethoxylate R¹⁰-(EO)—H with R¹⁰ being an aliphatic hydrocarbon group having from 1 to 25 carbon atoms or, an ethoxylated nonylphenol.

Preferably, the surfactant (e) is present in an amount of 0.00002 to 0.20 wt.-%, more preferably 0.0001 to 0.10 wt.-% based on the total weight of the binder composition.

When the surfactant (e) is present in the binder composition of the invention, the air bubble size of the binder composition can be further advantageously adjusted. Furthermore, the antifoaming agent is stabilized by the presence of the surfactant (e).

The binder composition of the present invention may further comprise an additive selected from the group consisting of a set accelerator, a set retarder, an anti-sag agent, a bonding agent, a dedusting agent, a reinforcing material, a biocide, and combinations thereof.

The binder composition of the present invention may further comprise at least one compound selected from the group consisting of a low charge polymer a neutral polymer, and mixtures thereof. Preferably, the binder composition may further comprise a polyvinyl alcohol.

Preferably, the low-charge polymer is branched, wherein one side-chain preferably is a polyether.

The invention further relates to a method for producing a hardened binder product in which pores with a predetermined size are distributed, the method comprising the steps of
(I) mixing water, an inorganic binder, and a dispersant yielding a binder slurry;
(II) providing a foaming agent;
(III) adding an antifoaming agent to the binder slurry of step (I) and/or the foaming agent of step (II);
(IV) combining the binder slurry obtained in step (I) and the foaming agent of step (II) yielding a foamed binder slurry;
(V) forming the foamed binder slurry into an article; and
(VI) allowing the article to set,
   wherein the antifoaming agent is added in an amount to adjust the pore size in the foamed binder product to a predetermined size;
   wherein the antifoaming agent is selected from the group consisting of a mineral oil, a vegetable oil, a silicon oil, a silicon containing emulsion, a fatty acid, a fatty acid ester, an organic modified polysiloxane, a borate ester, an alkoxylate, a polyoxialkylene copolymer, an ethylene oxide (EO)-propylene oxide (PO) block polymer, an acetylenic diol, and a phosphoric ester having the formula P(O)(O—R %)(O—R²)ₓ wherein P represents phosphorus, O represents oxygen and R¹ and R² are independently a C₂-C₂₀ alkyl, preferably a C₂-C₈ alkyl, or an aryl group and x=0, 1, 2; and
   wherein the dispersant comprises at least 30 wt % of a sulfonate group containing dispersant with respect to the total weight of the dispersant.

The binder and dispersant of the method of the present invention are the binder and the dispersant (d) as described above.

Water is added to the slurry in an amount to obtain a flowable slurry. The amount of water to be used varies significantly according to the application in which it is used, the nature of the dispersant, the properties of the binder (i.e. stucco) and the additives being used. The water to binder ratio (“WSR”) for gypsum wallboard production is preferably about 0.40 to about 1.20 based on the dry weight of the binder. Commonly a WSR of about 0.50 to about 0.90 is preferred.

Water used to obtain the slurry should be as pure as practical for best control of the properties of both the slurry and the set plaster. Salts and organic compounds are well known to modify the set time of the slurry, varying widely from accelerators to set inhibitors.

Some impurities lead to irregularities in the structure as the interlocking matrix of dihydrate crystals forms, reducing the strength of the set product. Product strength and consistency is thus enhanced by the use of water that is as contaminant-free as practical. Preferably, the water is distilled water.

The foaming agent of the method of the present invention is the foaming agent (c) as described above.

In a preferred embodiment, in step (II) the foaming agent is provided in the form of a preformed foam. The foam is pre-generated from an aqueous foaming agent solution. One method of making the foam is using a foam generator that mixes the foaming agent solution with air. Any method of mixing can be used to combine the foaming agent with solution air that causes bubbles to be formed, including agitation, turbulent flow or mixing. The amount of water and air are controlled to generate foam of a particular density. Adjustment of the foam volume is used to control the overall dry product weight.

In a preferred embodiment, the pore size adjusting agent comprises a surfactant.

Preferably, the surfactant of the method of the present invention is the surfactant (e) as described above.

The method of the present invention comprises a step (VI) of forming the foamed binder slurry into an article. The forming of an article from a foamed binder slurry is known to the person skilled in the art.

The method of the invention comprises a step (V) of allowing the article to set. This step is known to the person skilled in the art.

Preferably, the determined size of the pore size of the foamed binder product is in the range of 150-2000 μm, more preferably 200-800 μm. The antifoaming agent is preferably added in an amount of 0.00002 to 0.20 wt.-%, more preferably 0.0001 to 0.10 wt.-% with respect to the total weight of the binder.

The invention is further illustrated by the appended drawings and the examples that follow.

### Measurement Methods

### a) Wet Density

To determine the wet density of the gypsum compositions, the ratio between weight and volume was determined by introducing the respective composition into a beaker of known volume and then weighing.

### b) Foam Density

To determine the foam density, the ratio between weight and volume was determined by introducing the respective foam into a beaker of known volume and then weighing.

### c) Slump Test

Flow was determined after a time of 60 seconds. After adding powder components to liquid, the stucco had to soak for 15 seconds. Then the slurry was mixed for 30 seconds with a Hobart mixer. After a total time of 45 seconds an ASTM ring was filled with the stucco slurry up to the top edge and lifted after 60 seconds. At the end the patty diameter was measured with a calliper rule on two perpendicular axes.

### d) Hardening Time

Initial setting was determined with the so-called knife-cut method (analogous to DIN EN 13279-2).

### e) Flexural and Compressive Strength

Test specimens (4×4×16 cm³ prism) were prepared according to DIN 196-1 for investigation on strength development. Before testing flexural and compressive strength all samples were dried until mass consistency in the following way. After setting of the gypsum slurry all test specimens were stored at 20° C./65% relative humidity for one day. Afterwards all samples were stripped of the forms and then dried at 40° C. until mass consistency. Dry density (δT) was calculated by weighing and by volume (256 cm³).

### EXAMPLES

### Preparation of Foam 1

For this purpose, 7 g of Vinapor GYP 3711 commercially available by BASF SE (alkyl sulfate based), having 36% active compound, were dissolved in 1 liter of water, and converted to foam by means of a foam generator based on a rotor/stator system with addition of compressed air. The density of foam was 75 g/L.

### Preparation of Emulsion 1 (50% Active)

For this purpose, 10 g of antifoaming agent Polyglycol P-3000E commercially available by Dow Chemical and 15 g of antifoaming agent Degressal SD 40 commercially available by BASF SE (phosphoric ester) were mixed with 50 g of deionized water and 25 g of a styrene/maleic acid copolymer prepared according to example 5 of EP 0 306 449 A2 yielding emulsion 1.

### Comparative Example 1 (CE1)

For production of the gypsum slurry, 400 g of beta-hemihydrate (obtained from natural gypsum) were homogenized with 0.5 g of finely ground dihydrate and then introduced into 306.5 g of water that contained 0.50 g of a 40% aqueous solution of beta-naphthalene sulfonate plasticizer (NSF) and left to soak for 15 seconds. Subsequently, the mixture was charged into a mixing vessel (mixer according to DIN EN 196-1) and sheared for 30 seconds. During that time, Foam 1 (27.2 g with a density of 75 g/L) was added. The resulting fresh density of comparative mixture 1 was 888 g/dm³. Determined flow was 18.8 cm and initial set was 2:15 min:s.

### Comparative Example 2 (CE2)

For production of the gypsum slurry, 400 g of beta-hemihydrate (obtained from natural gypsum) were homogenized with 0.4 g of finely ground dihydrate and then introduced into 278.7 g of water that contained 3.0 g of a 40% aqueous solution of beta-naphthalene sulfonate plasticizer (NSF) and left to soak for 15 seconds. Subsequently, the mixture was charged into a mixing vessel (mixer according to DIN EN 196-1) and sheared for 30 seconds. During that time, foam 1 (29.5 g with a density of 75 g/L) was added. The resulting fresh density of comparative mixture 2 was 873 g/dm³. Determined flow was 19 cm and initial set was 2:15 min:s.

### Comparative Example 3 (CE3)

For production of the gypsum slurry, 400 g of beta-hemihydrate (obtained from natural gypsum) were homogenized with 0.5 g of finely ground dihydrate and then introduced into 289.3 g of water that contained 0.50 g of a 40% aqueous solution of beta-naphthalene sulfonate plasticizer (NSF) and left to soak for 15 seconds. Subsequently, the mixture was charged into a mixing vessel (mixer according to DIN EN 196-1) and sheared for 30 seconds. During that time, the Vinapor GYP 3711 based Foam 1 (20.4 g with a density of 75 g/L) was added. The resulting fresh density of comparative mixture 3 was 982 g/dm³. Determined flow was 19.2 cm and initial set was 2:15 min:s.

### Comparative Example 4 (CE4)

For production of the gypsum slurry, 400 g of beta-hemihydrate (obtained from natural gypsum) were homogenized with 0.4 g of finely ground dihydrate and then introduced into 265.9 g of water that contained 3.0 g of a 40% aqueous solution of beta-naphthalene sulfonate plasticizer (NSF) and left to soak for 15 seconds. Subsequently, the mixture was charged into a mixing vessel (mixer according to DIN EN 196-1) and sheared for 30 seconds. During that time, Foam 1 (20.4 g with a density of 75 g/L) was added. The resulting fresh density of comparative mixture 4 was 985 g/dm³. Determined flow was 19.1 cm and initial set was 2:05 min:s.

### Inventive Example 1 (IE1)

For production of the gypsum slurry, 400 g of beta-hemihydrate (obtained from natural gypsum) were homogenized with 0.4 g of finely ground dihydrate and then introduced into 292.2 g of water that contained 0.50 g of a 40% aqueous solution of beta-naphthalene sulfonate plasticizer (NSF) and left to soak for 15 seconds. In addition to comparative mixture 1, also 0.06 g of antifoaming agent (Pluronic RPE 3110 from BASF) were premixed in water. Subsequently, the mixture was charged into a mixing vessel (mixer according to DIN EN 196-1) and sheared for 30 seconds. During that time, Foam 1 (29.5 g with a density of 75 g/L) was added. The resulting fresh density of example mixture 1 was 852 g/dm³. Determined flow was 19.1 cm and initial set was 2:10 min:s.

TABLE 1
Summary of application test results

| | | Antifoaming | Foaming | | | | |
|---|---|---|---|---|---|---|---|
| | NSF | agent | agent | | | | |
| | % by weight | % by weight | % by weight | Water / | Flow | Initial set | Wet density |
| | stucco | stucco | stucco | stucco ratio | cm | min:s | g/dm³ |
| IE1 | 0.05 | 0.015 | 1.8585 | 0.805 | 19.1 | 2:10 | 852 |
| CE1 | 0.05 | — | 1.7136 | 0.835 | 18.5 | 2:20 | 888 |
| CE2 | 0.30 | — | 1.8585 | 0.775 | 18.8 | 2:15 | 873 |

Table 1 shows that the mixtures of IE1, CE1, and CE2 were established at similar flow, initial set and wet slurry density by use of varying additives. Higher amount of beta-naphthalene sulfonate (NSF) (dispersing agent (d)) enables further water reduction at same flow.

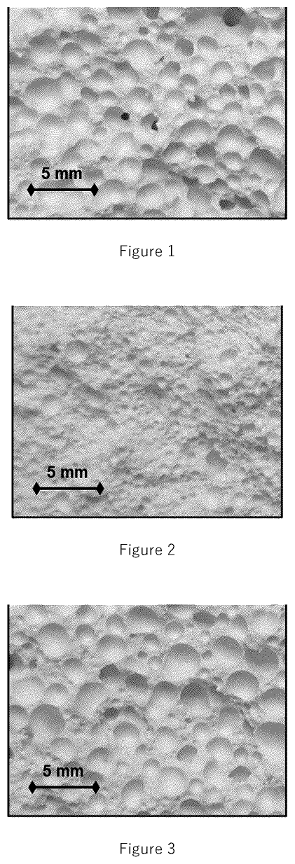

TABLE 2
Summary of strength investigation

| | | | Dry | | | |
|---|---|---|---|---|---|---|
| | | Initial | density | Flexural | Compressive | Pore |
| | Flow | set | (δT) | strength | strength | size |
| | cm | min:s | g/dm³ | N/mm² | N/mm² | mm |
| IE1 | 19.1 | 2:10 | 0.560 | 1.077 | 2.11 | ~1-3 (FIG. 1) |
| CE1 | 18.5 | 2:20 | 0.559 | 0.879 | 1.70 | <1 (FIG. 2) |
| CE2 | 18.8 | 2:15 | 0.574 | 1.092 | 2.47 | ~1-3 (FIG. 3) |

Comparing the results in Table 2 for IE1 and CE1, it can be shown that at the same densities, flows and setting times, by addition of antifoaming agent (to IE1), higher strength values are achievable in comparison to CE1, in particular at the same NSF dosage levels. At antifoaming agent dosage of 0.015% by weight of stucco, it was even possible to improve the flexural strength to the level of CE2, much higher than for CE1.

The comparison of the results in Table 2 for CE1 and CE2 show that the amount of used NSF has an impact on the air pore structure (bubble size). It can be seen that the air pores are larger at higher NSF dosages.

The addition of antifoaming agent (a) enables large air pores at lower NSF dosages, as established for IE1 (FIG. 1). Thus, the air pore size can be adjusted at constant foaming agent (a) usage, independent on NSF dosage, by addition of a respective amount of antifoaming agent. Large air pores provide higher compressive strength values in calcium sulfate-based binder.

### Inventive Example 2 (IE2)

For production of the gypsum slurry, 400 g of beta-hemihydrate (obtained from natural gypsum) were homogenized with 0.4 g of finely ground dihydrate and then introduced into 273.3 g of water that contained 0.50 g of a 40% aqueous solution of beta-naphthalene sulfonate plasticizer (NSF) and left to soak for 15 seconds. In addition to comparative mixture 3, also 0.015 g of emulsion 1 were premixed in water. Subsequently, the mixture was charged into a mixing vessel (mixer according to DIN EN 196-1) and sheared for 30 seconds. During that time, Foam 1 (20.4 g with a density of 75 g/L) was added. The resulting fresh density of example mixture 1 was 988 g/dm³. Determined flow was 19.1 cm and initial set was 2:05 min:s.

TABLE 3
Summary of application test results

| | | Antifoaming | Foaming | | | | |
|---|---|---|---|---|---|---|---|
| | NSF | agent | agent (active) | | | Initial | Wet |
| | % by weight | % by weight | % by weight | Water / | Flow | set | density |
| | stucco | stucco | stucco | stucco ratio | cm | min:s | g/dm³ |
| IE2 | 0.05 | 0.0009375 | 0.01285 | 0.735 | 19.1 | 2:05 | 988 |
| CE3 | 0.05 | — | 0.01285 | 0.775 | 19.2 | 2:15 | 982 |
| CE4 | 0.30 | — | 0.01285 | 0.720 | 19.1 | 2:05 | 985 |

Table 3 shows that the mixtures of IE2, CE3, and CE4 were established at similar flow, initial set and wet slurry density by use of varying additives. Higher amount of beta-naphthalene sulfonate (NSF) (dispersing agent (d)) enables further water reduction at same flow.

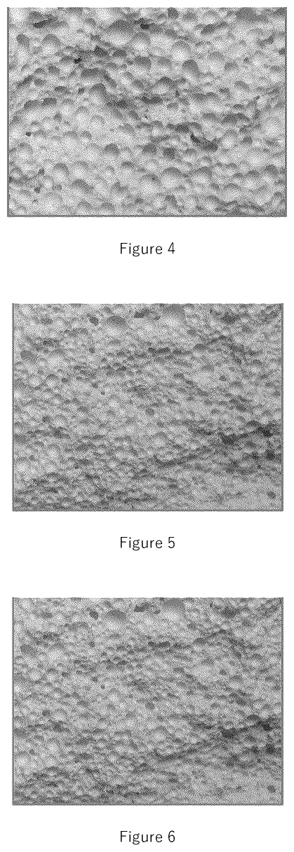

TABLE 4
Summary of strength investigation

| | | | Dry | | | |
|---|---|---|---|---|---|---|
| | | Initial | density | Flexural | Compressive | Pore |
| | Flow | set | (δT) | strength | strength | size |
| | cm | min:s | g/dm³ | N/mm² | N/mm² | mm |
| IE2 | 19.1 | 2:05 | 652 | 1.361 | 3.16 | ~1-3 (FIG. 4) |
| CE3 | 19.2 | 2:15 | 641 | 1.199 | 2.76 | <1 (FIG. 5) |
| CE4 | 19.1 | 2:05 | 662 | 1.438 | 3.51 | ~1-3 (FIG. 6) |

Comparing the results in Table 4 for IE2 and CE3, it can be shown that at the same densities, flows and setting times, by addition of emulsion 1 (to IE2), higher strength values are achievable in comparison to CE3, in particular at the same NSF dosage levels. At antifoaming dosage of 0.00375% by weight of stucco (0.001875% active by weight of stucco), it was even possible to improve the flexural strength to the level of CE4, much higher than for CE3.

The comparison of the results in Table 4 for CE3 and CE3 show that the amount of used NSF has an impact on the air pore structure (bubble size). It can be seen that the air pores are larger at higher NSF dosages.

The addition of emulsion 1 enables large air pores at lower NSF dosages, as established for IE2 (FIG. 4). Thus, the air pore size can be adjusted at constant foaming agent (a) usage, independent on NSF dosage, by addition of a respective amount of emulsion 1. Large air pores provide higher compressive strength values in calcium sulfate-based binder.

1.-15. (canceled)

16. A binder composition comprising:
(a) an antifoaming agent selected from the group consisting of a mineral oil, a vegetable oil, a silicon oil, a silicon containing emulsion, a fatty acid, a fatty acid ester, an organic modified polysiloxane, a borate ester, an alkoxylate, a polyoxialkylene copolymer, ethylene oxide (EO)-propylene oxide (PO) block polymer, acetylenic diols, and a phosphoric ester having the formula P(O)(O—R¹)₃₋ₓ(O—R²)ₓ wherein P represents phosphorus, O represents oxygen and R¹ and R² are independently a C₂-C₂₀ alkyl or an aryl group and x=0, 1, 2;
(b) an inorganic binder;
(c) a foaming agent; and
(d) a dispersant comprising at least 30 wt % of a sulfonate group containing dispersant with respect to the total weight of the dispersant.

17. The binder composition according to claim 16, wherein the antifoaming agent (a) comprises at least one compound selected from the group consisting of trialkyl phosphate, polyoxypropylene copolymer, glycerol/alcohol acetate, ethylene oxide (EO)-propylene oxide (PO) block polymer, or mixtures thereof.

18. The binder composition according to claim 16, wherein the binder composition comprises a surfactant (e) selected from the group consisting of a styrene/maleic acid copolymer, a alcohol alkoxylate, an acetylenic diol, a monoalkylpolyalkylene, an alkylethersulfonate, and an alkyl ether carboxylate.

19. The binder composition according to claim 16, wherein the foaming agent (c) comprises at least one compound selected from the group consisting of an alkyl polyglycoside, a betaine, a glutamate, a sulfo ketone, an alkyl sulfate, an alkyl aryl, an alkyl ether, an alkyl aryl ether, an alkyl ether an isethionate, a N-acylamino acid compound, a sulfoacetate, a sulfonate, a sulfosuccinate, a taurate, an alkanolamide, an amine oxide, a carboxylate, a cationic polymer, a silicone, an alcohol, a protein derivative, and mixtures thereof.

20. The binder composition according to claim 16, wherein the antifoaming agent (a) and the foaming agent (c) are present in a ratio ((a):(c)) of 1:2000 to 1:1.

21. The binder composition according to claim 16, wherein the foaming agent (c) comprises at least 50 wt % of a compound selected from the group consisting of an alkyl sulfate, an alkyl polyglycoside, and mixtures thereof.

22. The binder composition according to claim 16, wherein the sulfonate group containing dispersant comprised in the dispersant (d) is selected from the group consisting of a polynaphthalene sulfonate, a ketone resin, a melamine resin, a lignosulfonate, and mixtures thereof.

23. The binder composition according to claim 22, wherein the sulfonate group containing dispersant is a naphthalene sulfonate-formaldehyde condensate.

24. The binder composition according to claim 16, wherein the inorganic binder (b) is selected from the group consisting of cement, gypsum, and a mixture thereof.

25. The binder composition according to claim 24, wherein the gypsum is selected from the group consisting of natural gypsum, calcium sulfate, calcined gypsum, calcium sulfate hemihydrate, calcium sulfate anhydrite, plaster of Paris, synthetic gypsum, or recycled gypsum.

26. The binder composition according to claim 25, wherein the synthetic gypsum is formed as a by-product of the flue gas desulfurization.

27. The binder composition according to claim 25, wherein the recycled gypsum
is selected from the group consisting of stucco gypsum, mortar gypsum, machine gypsum plaster, plastering gypsum, bonding gypsum, jointing gypsum, filling gypsum, insulating gypsum, flooring gypsum, ready-mixed plaster gypsum, imitation marbles, gypsum-containing ready-made structural components, and mixtures thereof; or
comprises siloxanes, wax emulsions, or combinations thereof.

28. The binder composition according to claim 16, wherein the dispersant (d) consists of the sulfonate group containing dispersant.

29. A method for producing a hardened binder product having pores with a predetermined pore size, the method comprising the steps of
(I) mixing water, an inorganic binder, and a dispersant yielding a binder slurry;
(II) providing a foaming agent;
(III) adding an antifoaming agent to the binder slurry of step (I) or the foaming agent of step (II);
(IV) combining the binder slurry of step (I) with the foaming agent yielding a foamed binder slurry,
(V) forming the foamed binder slurry into an article; and
(VI) allowing the article to set,
wherein the antifoaming agent is added in an amount to adjust the pore sizes of the pores in the foamed binder product to a predetermined size;
wherein the antifoaming agent is selected from the group consisting of a mineral oil, a vegetable oil, a silicon oil, a silicon containing emulsion, a fatty acid, a fatty acid ester, an organic modified polysiloxane, a borate ester, an alkoxylate, a polyoxialkylene copolymer, an ethylene oxide (EO)-propylene oxide (PO) block polymer, an acetylenic diol, and a phosphoric ester having the formula P(O)(O—R¹)₃₋ₓ(O—R²)ₓ wherein P represents phosphorus, O represents oxygen and R¹ and R² are independently a C₂-C₂₀ alkyl or an aryl group and x=0, 1, 2, and
wherein the dispersant comprises at least 30 wt % of a sulfonate group containing dispersant with respect to the total weight of the dispersant.

30. The method according to claim 29, wherein
in step (II) the foaming agent is provided in the form of a preformed foam produced from the foaming agent; or
in step (I) the dispersant is selected from the group consisting of a polynaphthalene sulfonate, a ketone resin, a melamine resin, a lignosulfonate, and mixtures thereof.

31. The method according to claim 29, wherein the inorganic binder is selected from the group consisting of cement, gypsum, and a mixture thereof.

32. The method according to claim 31, wherein the binder is selected from the group consisting of natural gypsum, calcium sulfate, calcined gypsum, calcium sulfate hemihydrate, calcium sulfate anhydrite, plaster of Paris, synthetic gypsum, or recycled gypsum.

33. The method according to claim 32, wherein the synthetic gypsum is formed as a by-product of the flue gas desulfurization.
